(19) United States
(12) Patent Application Publication
(10) Pub. No.: US 2011/0309047 A1
(43) Pub. Date: Dec. 22, 2011

(54) Vent Unit and Container Utilizing Same

(76) Inventor: Dominick J. Fucito, Sagamore Beach, MA (US)

(21) Appl. No.: 13/166,857

(22) Filed: Jun. 23, 2011

Related U.S. Application Data
(63) Continuation-in-part of application No. 12/317,597, filed on Dec. 27, 2008.
Application No. 12/317,597 is a continuation-in-part of application No. 12/215,781, filed on Jun. 30, 2008, now Pat. No. 7,984,818.

(51) Int. Cl. A61J 9/04

(52) U.S. Cl. 215/11.5

(57) ABSTRACT

An improved vent unit for a container such as a bottle, and a bottle assembly utilizing same. The vent unit includes a vent insert having an upper portion capable of sealingly engaging an opening in an upper region of the container and having a lower portion including a vent tube communicating with the atmosphere through at least one air passage in the upper portion. The upper portion defines at least one channel for liquid in the container to flow past the opening in the container. The vent unit also includes a vent conduit having upper and lower ends and defining a vent passage there-between. The upper end of the vent conduit is connectable with the vent insert to communicate with the vent tube, and at least a portion of the vent conduit is flexible. At least one buoyant element is associated with the vent conduit to enable the lower end of the vent conduit to float in liquid within the container at least when the container is realigned from a vertical position to a horizontal position.

### CROSS-REFERENCE TO RELATED APPLICATIONS

This application is a Continuation-In-Part of application Ser. No. 12/317,597 filed Dec. 27, 2008, which is a Continuation-In-Part of application Ser. No. 12/215,781 filed Jun. 30, 2008, now U.S. Pat. No. ______.

### FIELD OF INVENTION

This invention generally relates to an improved vented container such as a nursing bottle, and more particularly to an improved vent unit which minimizes leaks from liquid within the container.

### BACKGROUND OF INVENTION

Nursing bottles have been used for many years to feed babies, as a convenient alternative to breast feeding. This alternate method eliminates the discomfort often associated with breast feeding and allows care givers other than the maternal parent to perform this feeding. Moreover, the amount fed to the baby using this alternative can be accurately monitored.

Despite its numerous advantages however, there are several disadvantages. One significant disadvantage is the difficulty associated with dispensing the liquid from the bottle. As liquid is dispensed, a partial vacuum forms in the bottle, making further dispensing of liquid more difficult. Many prior art designs have sought to eliminate this disadvantage, with limited success. These prior art designs can be broadly categorized into two types: variable volume designs and vented designs. These are discussed in more detail in the paragraphs below.

A variable volume bottle design is one in which the volume of the container diminishes as the liquid is dispensed. One example of this design is disclosed in U.S. Pat. No. 4,880,125. As indicated therein, the design utilizes a collapsible bag set inside a rigid container, and replacement of the container bottom with a plunger which is depressed to reduce the effective bag volume as the liquid is dispensed. There are a number of weaknesses in this design however. First, inadvertent application of excess force to the plunger could result in dispensing liquid to the baby at a rate which exceeds the baby's consumption. This could cause the baby to gag or could result in spillage. In addition, collapsible liners are, by necessity, fragile and must be replaced frequently, making their use expensive. Also, handling and use of this design is difficult due to its cumbersome shape when assembled.

Another variable volume bottle design is disclosed in U.S. Pat. No. 6,616,000. As indicated therein, that design also incorporates a collapsible liner which must be replaced frequently. In addition, the liner assumes an irregular shape as it collapses during use, making it difficult to determine the quantity of liquid consumed by the baby.

Many vented bottle designs have been developed in the prior art to try to reduce or eliminate the development of a partial vacuum in the bottle during feeding. One example is disclosed in U.S. Pat. No. 6,742,665. As indicated therein, the venting apparatus consists of a spring loaded valve which is opened to allow air to enter the bottle. There are weaknesses associated with this design as well. These types of bottles are prone to leakage if foreign material becomes lodged in the valve seal, or if the valve is inadvertently opened when the bottle is not sufficiently inverted. In addition, use of a spring mechanism leads to additional expense in manufacturing.

Another vented bottle design is disclosed in U.S. Pat. No. 5,779,071 by Brown et al., with Reexamination Certificate No. U.S. Pat. No. 5,779,071 C1 issued Aug. 12, 2008, which is incorporated herein by reference in its entirety. As indicated therein, venting apparatus is incorporated into the design and the geometry of this apparatus is intended to vent the bottle to the atmosphere, yet not allow leakage through the vent path. However, this design is prone to significant leakage under certain conditions, as illustrated in FIGS. 1 through 6 in the present application. Referring to FIGS. 1 and 2, this prior art design consists of a container 100, a vent unit 200, a nipple 300, and a collar 400. The vent unit 200 consists of a vent insert 210 and a reservoir tube 220. The container has a marking 103 which prescribes the maximum fill level of the container. FIG. 3 illustrates a cross section of the assembled prior art bottle, after being filled with liquid to the prescribed level and then rotated into a substantially horizontal orientation. In this figure, the light shading represents a liquid inside the container (container liquid) 500, and the dark shading represents a liquid inside the reservoir tube (reservoir liquid) 600. As illustrated in FIGS. 4 and 5, significant leakage can occur if pressure is applied to the nipple 300 while the bottle is in the horizontal position. This application of pressure is most often due to the baby chewing on the nipple. Referring to FIG. 4, pressure applied to the nipple 300 causes the container liquid 500 to be forced into the vent unit 200 and results in accumulation of additional reservoir liquid 601. Referring to FIG. 5, as pressure on the nipple 300 is relieved, air 602 is drawn out of the vent unit 200. Referring to FIG. 6, as pressure is then reapplied, additional liquid is forced into the vent unit 200. When the liquid level inside the vent unit 200 reaches the center of a vent insert 210, it will leak out of the bottle through the vent insert.

The weakness in prior art design disclosed in U.S. Pat. No. 5,779,071 is recognized in published application US 2005/0258124 A1. As indicated therein, the weakness is addressed by changing the shape of the bottle and limiting the quantity of liquid to be contained therein such that the vent insert is never submerged. This new design has a number of disadvantages however. First, the oversized shape of the bottle will be difficult for a baby to hold. Second, the design significantly limits the quantity of liquid which can be placed in each bottle, potentially resulting in the need to use multiple bottles to administer an adequate feeding.

Another prior art design of this type is disclosed in U.S. Pat. No. 5,570,796. This design also utilizes a reservoir tube and vent insert, but must be oriented with the reservoir tube and vent insert facing upward to prevent leakage.

### OBJECTS AND ADVANTAGES

The object of the present invention is to provide an improved vent unit design which enables a bottle or other container to be fully vented, eliminates the potential for leakage described in the paragraphs above, is easy to clean, and does not require that the container be used in a specific orientation.

### SUMMARY OF THE INVENTION

The present invention features an improved vent unit installable inside a container which allows air to enter the container through one or more air passages but will not allow liquid to escape through the air passages. The vent unit includes a vent insert having an upper portion capable of sealingly engaging an opening in an upper region of the container and having a lower portion including a vent tube communicating with the atmosphere through at least one air passage in the upper portion. The upper portion defines at least one channel for liquid in the container to flow past the opening in the container. The vent unit also includes a vent conduit having upper and lower ends and defining a vent passage there-between. The upper end of the vent conduit is connectable with the vent insert to communicate with the vent tube, and at least a portion of the vent conduit is flexible. At least one buoyant element is associated with the vent conduit to enable the lower end of the vent conduit to float in liquid within the container at least when the container is realigned from a vertical position to a horizontal position.

If pressure is applied to the nipple in a substantially horizontal orientation, preferably air rather than liquid is forced into the vent unit. Therefore, liquid will not accumulate into and leak out of the vent unit. Since this design relies on forces due to buoyancy which always act in the upward direction to keep the end of the vent unit from being submerged, the new design will minimize leakage regardless of its orientation.

In some embodiments, upper end of the vent conduit includes an expanded reservoir region which envelops the vent tube. In other embodiments, the upper end of the vent conduit is connectable directly with the vent tube of the vent insert, and the upper portion of the vent insert defines at least one collection chamber to hold liquid drained from the vent passage of the vent conduit when the container is realigned from the vertical position to the horizontal position. In certain embodiments, the buoyant element includes at least one chamber containing a gas.

This invention may also be expressed as an improved bottle assembly including a bottle having an opening in an upper region and capable of carrying a pre-selected quantity of liquid in at least a lower region of the bottle. A vent unit is installed in the bottle and includes:

(a) a vent insert having an upper portion capable of sealingly engaging the opening in the bottle and having a lower portion including a vent tube communicating with the atmosphere through at least two spaced-apart air passages in the upper portion, and the upper portion defining at least two spaced-apart channels for liquid in the bottle to flow past the opening in the bottle;

(b) a vent conduit having upper and lower ends and defining a vent passage there-between, the upper end being connectable with the vent insert to communicate with the vent tube, and at least a portion of the vent conduit being flexible; and

(c) at least one buoyant element associated with the vent conduit to enable the lower end of the vent conduit to float in liquid within the bottle at least when the bottle is realigned from a vertical position to a horizontal position.

### BRIEF DESCRIPTION OF THE DRAWINGS

In what follows, preferred embodiments of the invention are explained in more detail with reference to the drawings, in which:

FIG. 1 is a side view of a prior art bottle assembly;

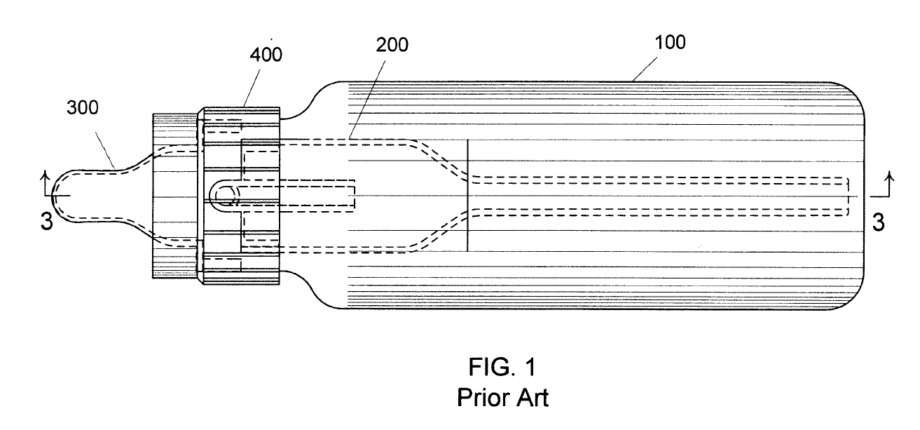

FIG. 2 is an exploded side view of the individual parts disclosed in the prior art design illustrated in FIG. 1;

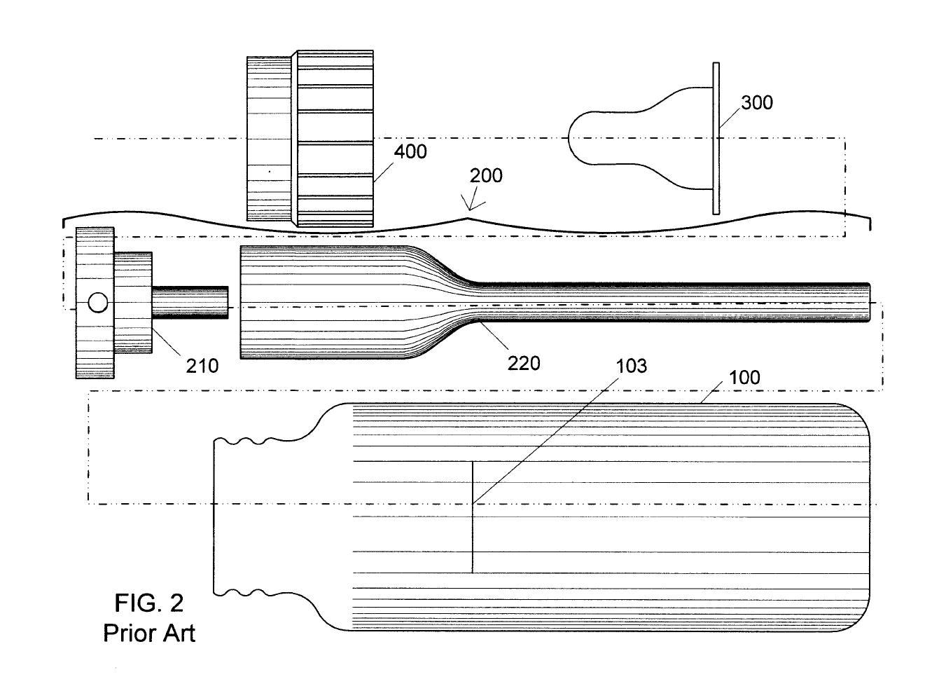

FIG. 3 is a sectional view of the prior art design, taken along line 3-3 of FIG. 1, and filled with liquid to a prescribed level;

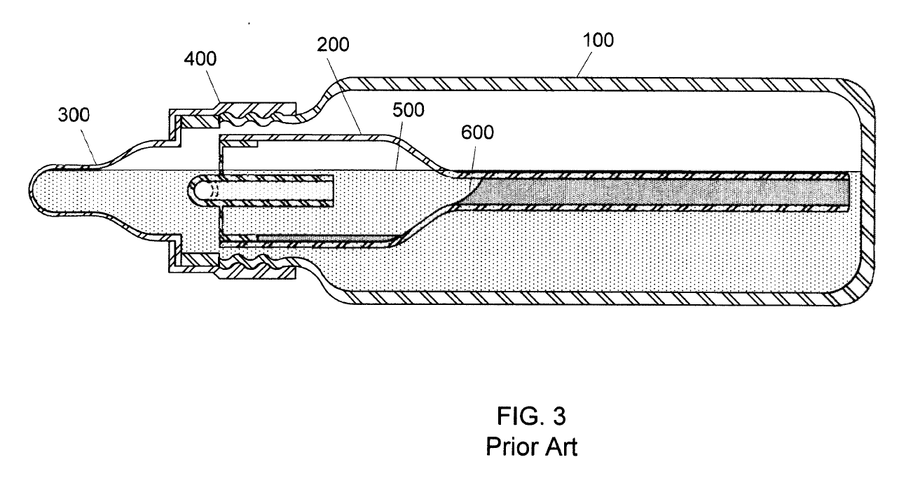

FIG. 4 is a sectional view of the prior art design illustrating the consequences of initially pressurizing the nipple;

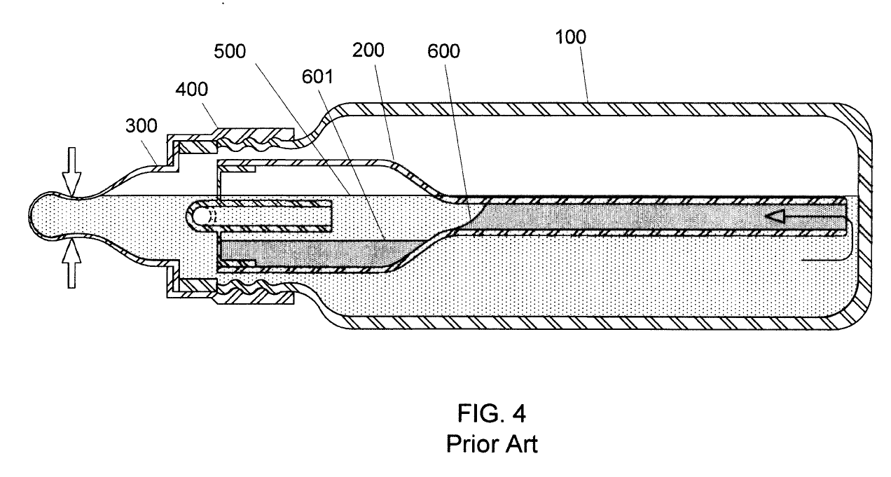

FIG. 5 is a sectional view of the prior art design illustrating the effect of relieving the pressure on the nipple;

FIG. 6 is a sectional view of the prior art design illustrating the leakage path resulting from re-pressurizing the nipple;

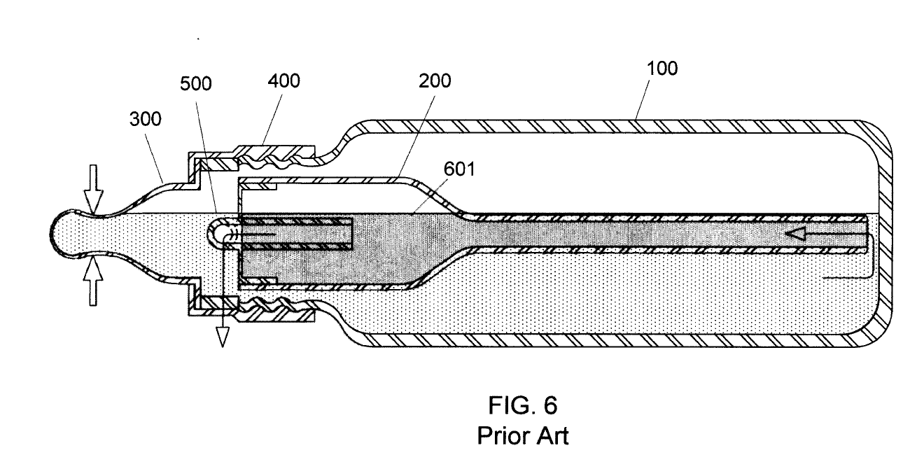

FIG. 7 is a side view of a preferred embodiment of a vented bottle according to the present invention;

FIG. 8 is a sectional view of the vented bottle of FIG. 7, taken along line 8-8;

FIG. 9 is an exploded side view of the individual parts of the vented bottle of FIG. 7;

FIG. 10 is an exploded side view of the vent unit shown in FIG. 9;

FIG. 11 is a sectional view of the reservoir tube shown in FIGS. 9 and 10, taken along line 11-11;

FIG. 12 is a sectional view of the vented bottle of FIG. 7 filled with liquid to a prescribed level in an upright position;

FIG. 13 is a sectional view of the vented bottle of FIG. 12 filled with liquid to a prescribed level, then rotated into a substantially horizontal position;

FIG. 14 is a sectional view of the vented bottle of FIGS. 12 and 13 rotated into an inverted position;

FIG. 15 is a sectional view of the vented bottle of FIGS. 12-14 returned to a substantially horizontal position, showing the effect of applying pressure to the nipple;

FIG. 16 is a side view of a first alternate embodiment of the improved reservoir tube according to the present invention;

FIG. 17 is a sectional view of the first alternate embodiment of the improved reservoir tube, taken along line 17-17 of FIG. 16;

FIG. 18 is a sectional view of the first alternate embodiment incorporated into the improved bottle assembly, rotated into a substantially horizontal orientation;

FIG. 19 is a sectional view of a second alternate embodiment of the improved reservoir tube according to the present invention;

FIG. 20 is a sectional view of the first alternate embodiment incorporated into the improved bottle assembly, rotated into a position less than horizontal;

FIG. 21 is a sectional view of the first alternate embodiment incorporated into the improved bottle assembly, rotated into a position less than horizontal, showing the effect of pressurizing the nipple.

FIG. 22 is a sectional view of the first alternate embodiment incorporated into the improved bottle assembly, rotated into a position less than horizontal, showing the effect of relieving pressure applied to the nipple.

FIG. 23 is a sectional view of another alternate embodiment of the present invention;

FIG. 24 is a sectional view of an alternate embodiment of the present invention;

FIG. 25 is a side view of an alternative vent insert according to the present invention;

FIG. 26 is a top view of the insert of FIG. 25 showing internal components in phantom;

FIG. 27 is a side cross-sectional view along line 27-27 of FIG. 26;

FIG. 28A is a view similar to FIG. 27 with the insert rotated ninety degrees from a vertical position to a horizontal position to illustrate capture of vent liquid in chambers within the insert;

FIG. 28B is a side cross-sectional view of an alternative vent bottle according to the present invention, in an empty condition and vertical position, showing the vent insert of

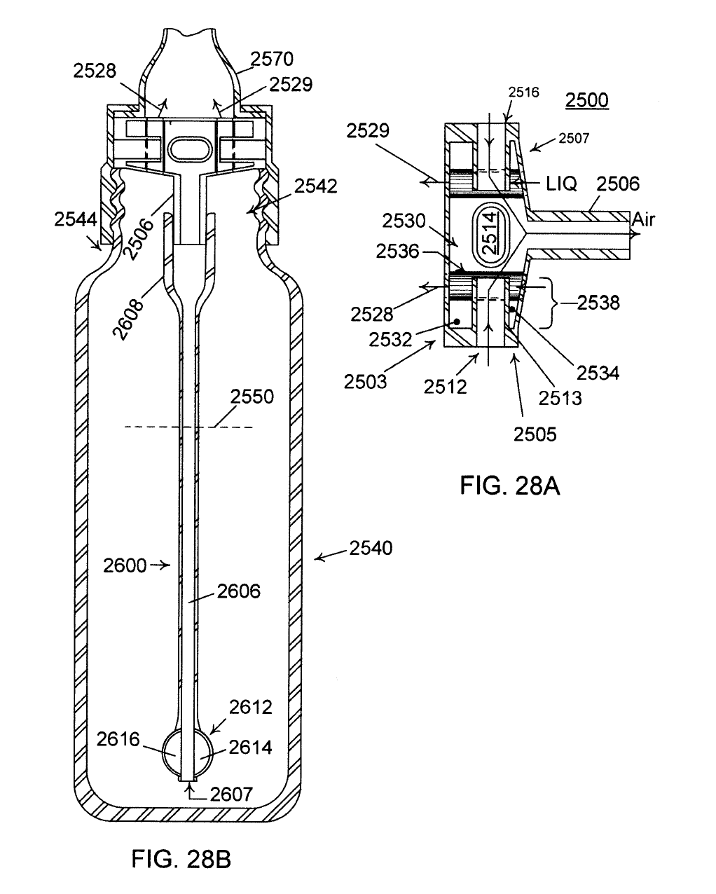

FIGS. 26-28A together with an alternative vent conduit according to the present invention;

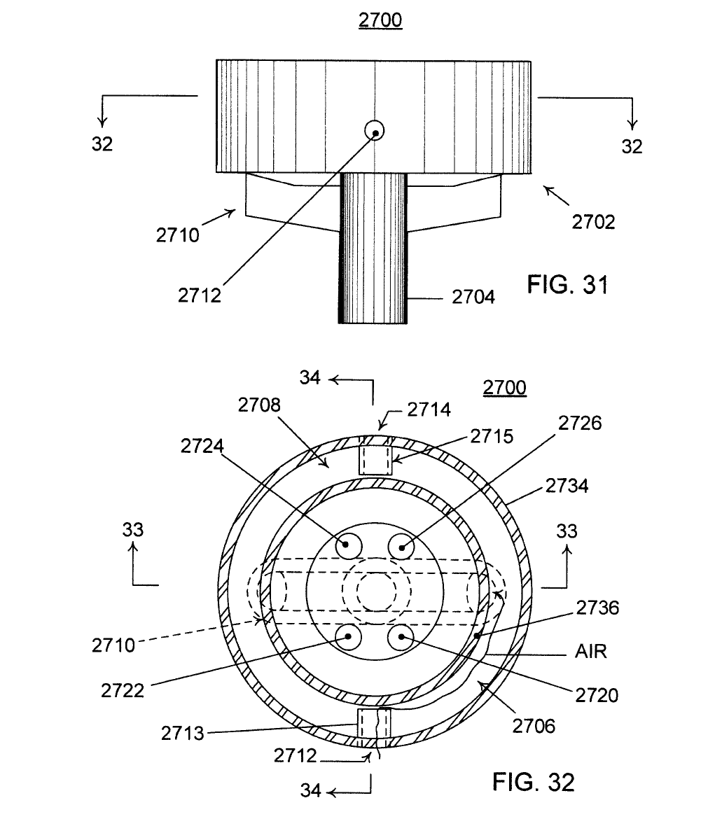

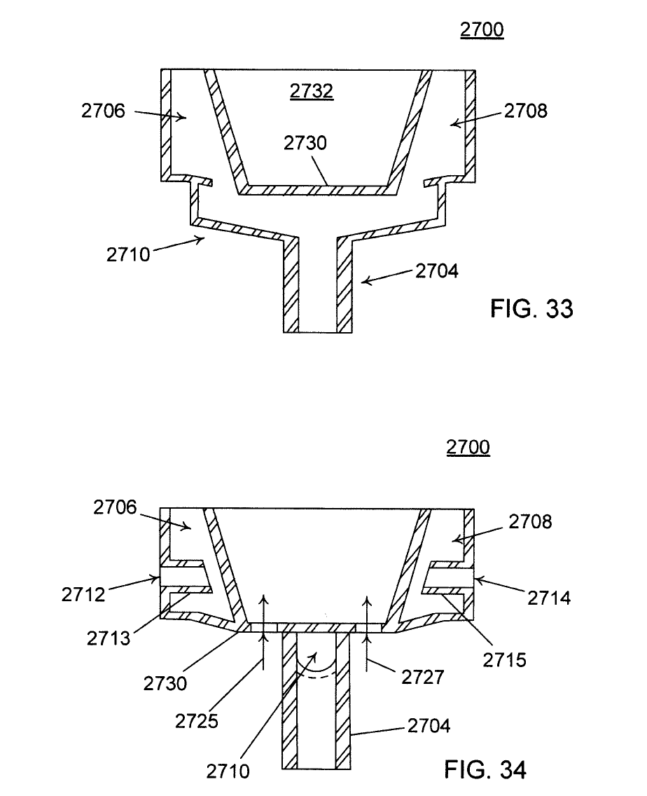

FIG. 29 is a side view of the vent conduit of FIG. 28B;

FIG. 30 is a side cross-sectional view of the vent bottle of FIG. 28B in a full condition and vertical position;

FIG. 31 is a side view of yet another vent insert according to the present invention;

FIG. 32 is a top cross-sectional view along line 32-32 of FIG. 31;

FIG. 33 is a side cross-sectional view along line 33-33 of FIG. 32; and

FIG. 34 is a side cross-sectional view along line 34-34 of FIG. 32.

### DETAILED DESCRIPTION OF THE PRESENTLY PREFERRED EMBODIMENTS

This invention may be accomplished by a vent unit including a vent insert having an upper portion capable of sealingly engaging an opening in an upper region of a container and having a lower portion including a vent tube communicating with the atmosphere through at least one air passage in the upper portion. The upper portion defines at least one channel for liquid in the container to flow past the opening in the container. The vent unit also includes a vent conduit having upper and lower ends and defining a vent passage there-between. The upper end of the vent conduit is connectable with the vent insert to communicate with the vent tube, and at least a portion of the vent conduit is flexible. At least one buoyant element is associated with the vent conduit to enable the lower end of the vent conduit to float in liquid within the container at least when the container is realigned from a vertical position to a horizontal position.

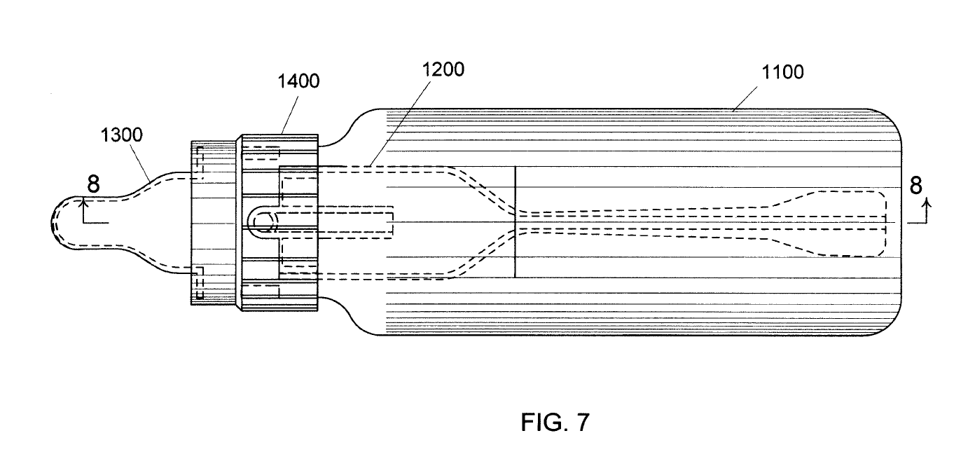

A preferred vent bottle of the present invention is illustrated in FIGS. 7 through 11 having a container 1100, a vent unit 1200, a nipple 1300, and a collar 1400. The container 1100 has a circular open top 1101, threads 1102 to engage the collar 1400, and a marking 1103 to indicate the maximum fill level of the container, based on a pre-selected quantity of liquid to be carried in container 1100.

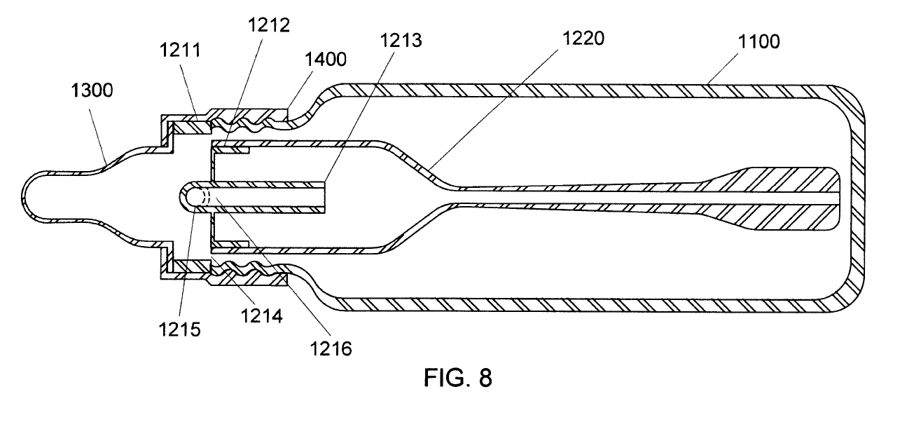

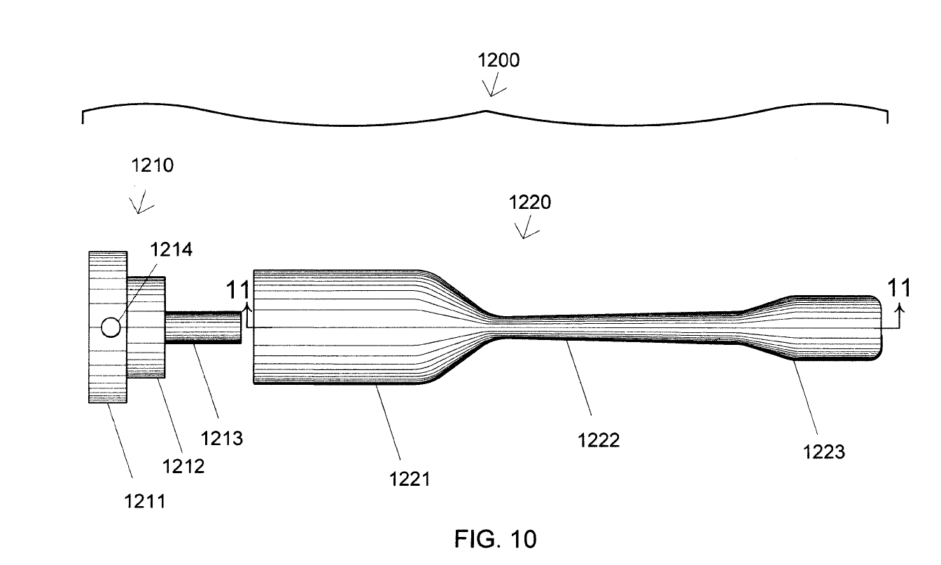

As indicated in FIG. 10, the preferred embodiment of the vent unit 1200 is composed of two distinct elements: a vent insert 1210 and a vent conduit shaped as a reservoir tube 1220 in this embodiment. The vent insert 1210 consists of a flange 1211, a shoulder 1212, and a vent tube 1213. The flange 1211 is circular, with an outside diameter substantially equal to the outside diameter of the container top 1101. As best illustrated in FIG. 8, the interface between the flange 1211 and shoulder 1212 has at least one opening 1214 to allow the passage of liquids. The flange 1211 also incorporates a passage 1215 which starts on the side of the flange 1211, runs radially to the center of the flange and ends on its underside. As best illustrated in FIG. 8, the shoulder 1212 of the preferred embodiment is circular, with a central opening 1216 aligned with the flange passage 1215. The vent tube 1213 is a circular hollow tube aligned with the central opening 1216 of the shoulder 1212.

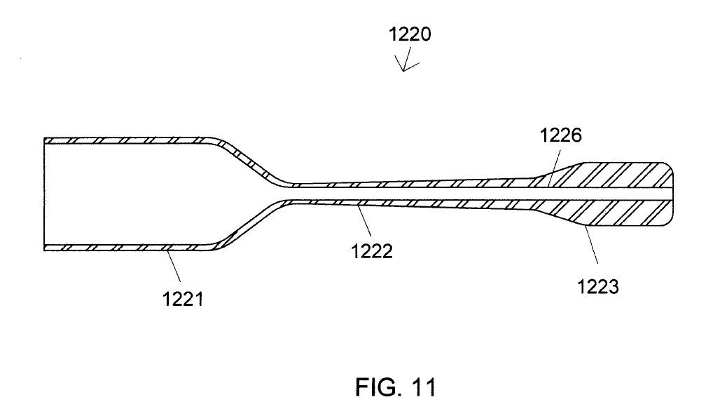

As best illustrated in FIG. 11, the reservoir tube 1220 of the preferred embodiment is a homogeneous element consisting of a reservoir 1221, a stem 1222, and a float 1223. These elements of the reservoir tube 1220 are hollow and of circular cross section, creating a central opening 1226. The reservoir 1221 wall is relatively thin, and its inside diameter is sized to fit tightly over the shoulder 1212 of the vent insert 1210. The stem 1222 wall is also relatively thin, and its inside diameter is significantly smaller than the inside diameter of the reservoir 1222. The float 1223 wall is relatively thick, and its inside diameter is substantially equal to the inside diameter of the stem 1222. The overall length of the reservoir tube 1220 is sized so that the bottom of the tube is in close proximity to the bottom of the container 1100 when the elements are assembled. The inside volume of the reservoir 1221 is sized so that a volume of liquid equal to the inside volume of the stem 1222, including the portion of the central opening 1226 underlying the float 1223, when transferred into the reservoir 1221 could not submerge the lower end of the vent tube 1213 regardless of the spatial orientation of the reservoir tube 1220 when the elements are assembled. The preferred embodiment of the reservoir tube 1220 is constructed from a flexible and buoyant closed cell foam rubber material. The degree of flexibility and buoyancy required for this material will become apparent in the discussion of the operation of the preferred embodiment which is presented below.

The nipple 1300 of this preferred embodiment is conventional in design. It is constructed from a flexible synthetic rubber and includes a nipple body 1301 with a central hole 1302, and a nipple flange 1303. The flange is circular with an outside diameter substantially equal to the outside diameter of the vent insert flange 1211 and container top 1101.

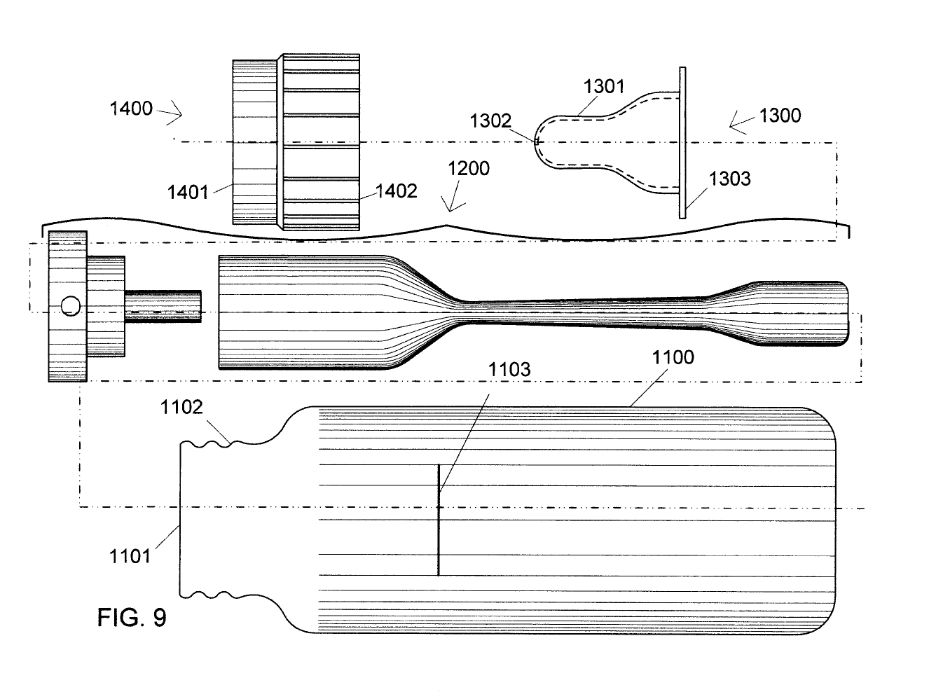

The collar 1400 of this preferred embodiment is also of conventional design. It is constructed of hard plastic and includes an upper portion 1401 and a lower portion 1402, FIG. 9. The upper portion 1401 is sized to accommodate the thickness of the vent insert flange 1211 and the nipple flange 1303 when assembled, as best illustrated in FIG. 8. The lower portion 1402 is designed to engage with the container threads 1102 and develop sufficient force when engaged to make an effective seal at the nipple/vent insert and vent insert/container interfaces.

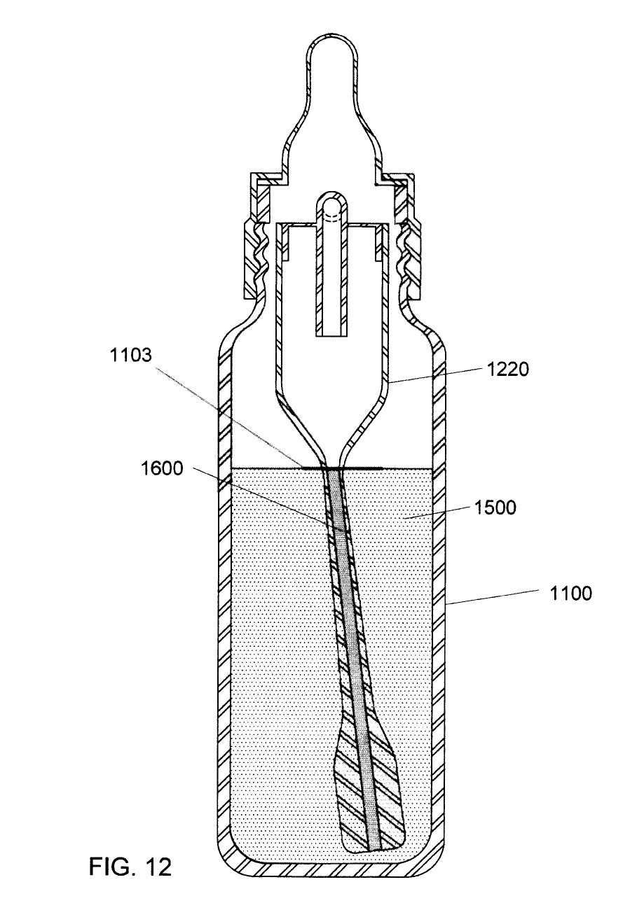

### FIGS. 12 Through 15

### Operation of Preferred Embodiment

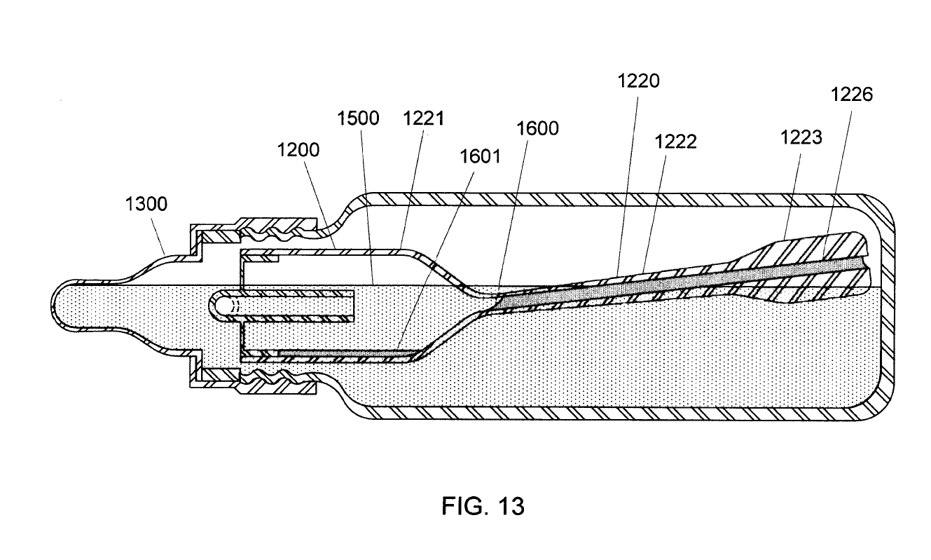

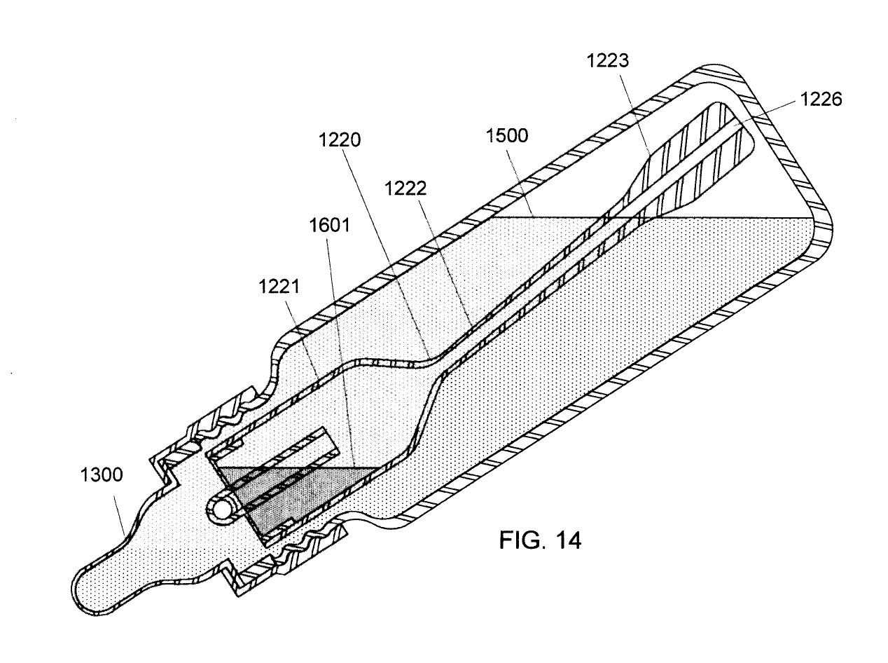

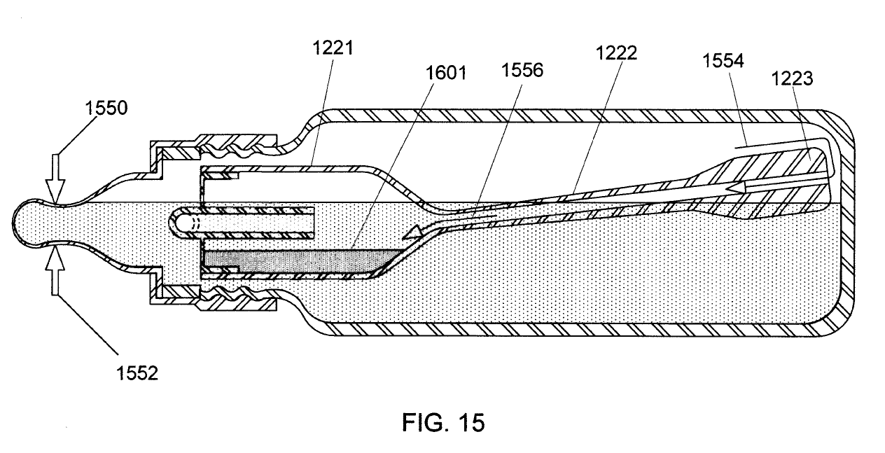

Operation of the preferred embodiment of FIGS. 7-11 is illustrated in FIGS. 12 through 15. As indicated in FIG. 12, the container 1100 is filled with liquid 1500 until the level reaches the marking 1103. Some of this liquid 1500, referred to as vent liquid 1600, a portion of which may become reservoir liquid 1601 in this construction, flows up into the reservoir tube 1220 also up to the level of the marking 1103. The bottle is then fully assembled as shown. To use the filled and assembled bottle, it is rotated into a substantially horizontal position as shown in FIG. 13, or an inverted position as shown in FIG. 14. In the horizontal position, the flexibility and buoyancy of the reservoir tube 1220 causes its bottom to float so that the bottom of the central opening 1226 is above the level of the container liquid 1500. While in either horizontal or inverted positions, the vent liquid 1600 may stay within the stem 1222 or float 1223 due to adhesive forces between the liquid and the stem/float material, as shown in FIG. 13, or may migrate substantially entirely into the reservoir 1221 due to gravity, as shown in FIG. 14 as reservoir liquid 1601. The application of pressure to the nipple 1300, indicated by arrows 1550 and 1552 in FIG. 15, pressurizes the inside of the container and forces air, represented by arrow 1554, into stem 1222, which then typically causes the vent liquid 1600 to be forced into the reservoir, as represented by arrow 1556, to become reservoir liquid 1601. Once stem 1222 is emptied into reservoir 1221, no additional liquid is added to reservoir 1221 because no additional liquid can enter the central opening 1226 while in a horizontal or inverted position since the bottom of the central opening 1226 is maintained by float 1223 above the container liquid level. And since the reservoir 1221 volume has been specifically sized, this reservoir liquid 1601 cannot enter the vent tube 1213 regardless of the orientation of the bottle assembly. Due to these unique combination of features, liquid cannot enter into and escape from the vent insert when the bottle is in a substantially horizontal or inverted orientation.

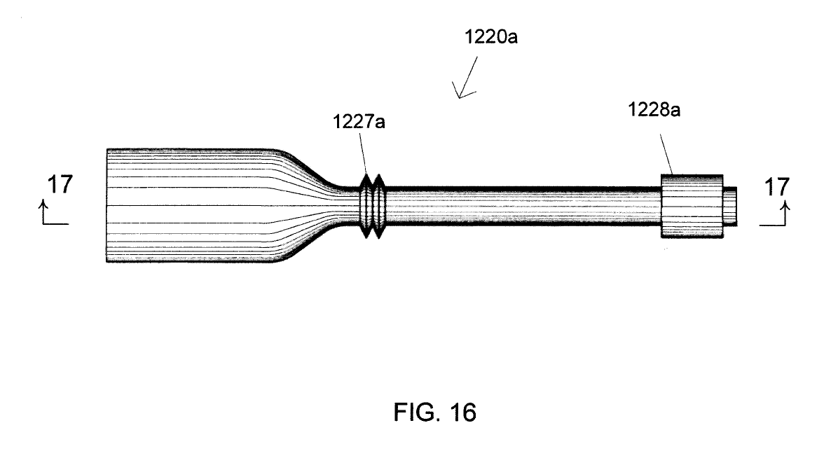

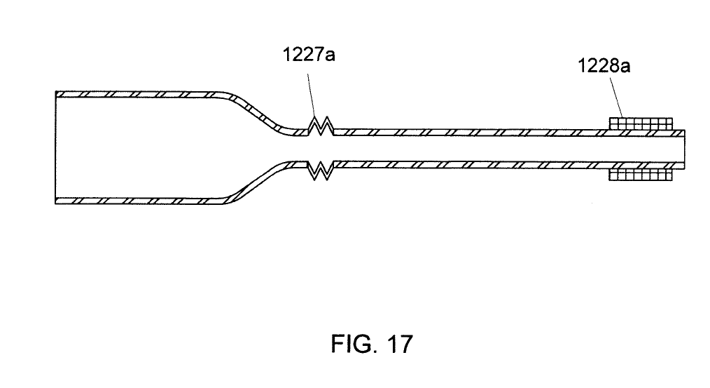

### FIGS. 16 Through 24

### Alternate Embodiments

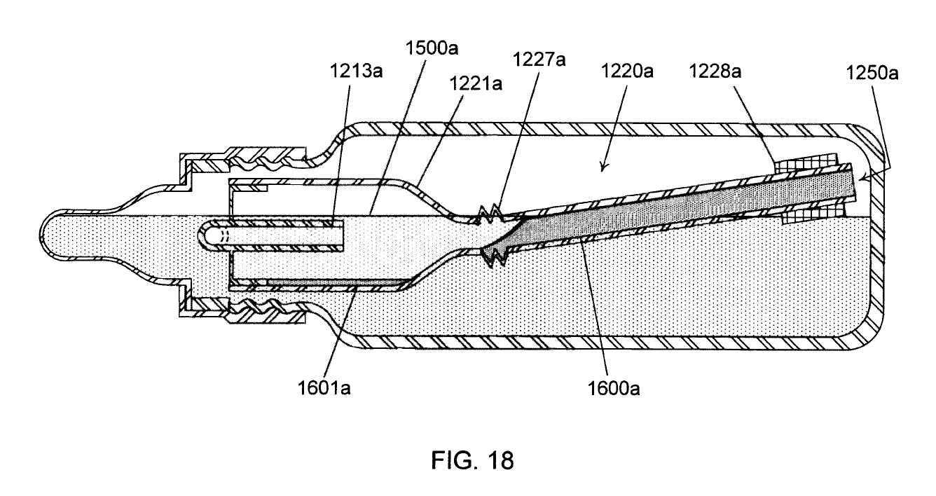

A number of alternate embodiments of the present invention are possible. A first alternate embodiment is illustrated in FIGS. 16 through 18. As indicated therein for one construction, the reservoir tube 1220a incorporates a distinct flexible element 1227a in lieu of or, in another construction, to supplement, forming the entire tube from flexible material. In addition, the tube 1220a incorporates a distinct buoyant element 1228a in lieu of or, in another construction, to supplement, forming the entire tube from a buoyant material. As illustrated in FIG. 18, the distinct flexible element 1227a and buoyant element 1228a would be sized so that the bottom of the tube 1220a, with opening 1250a, is above the water level of liquid 1500a when in a substantially horizontal configuration. Reservoir 1221a is sized to accommodate reservoir liquid 1601a accumulating from vent liquid 1600a such that liquid does not enter vent tube 1213a.

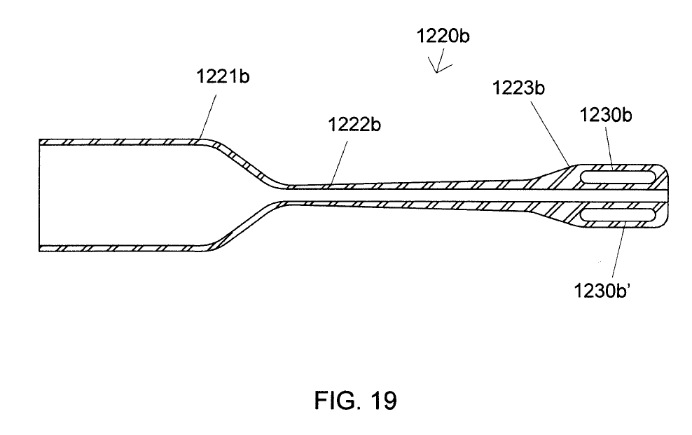

A second alternate embodiment is illustrated in FIG. 19 for reservoir tube 1220b having reservoir 1221b, stem 1222b, and float 1223b. As indicated therein for one construction, at least one air pocket 1230b, 1230b′ is incorporated into the float 1223b to increase buoyancy. The inclusion of this air pocket 1230b, 1230b′, which is toroidal in one construction and is independent, separate pockets in other constructions, could be in lieu of or in addition to constructing entire vent tube 1220b from buoyant material.

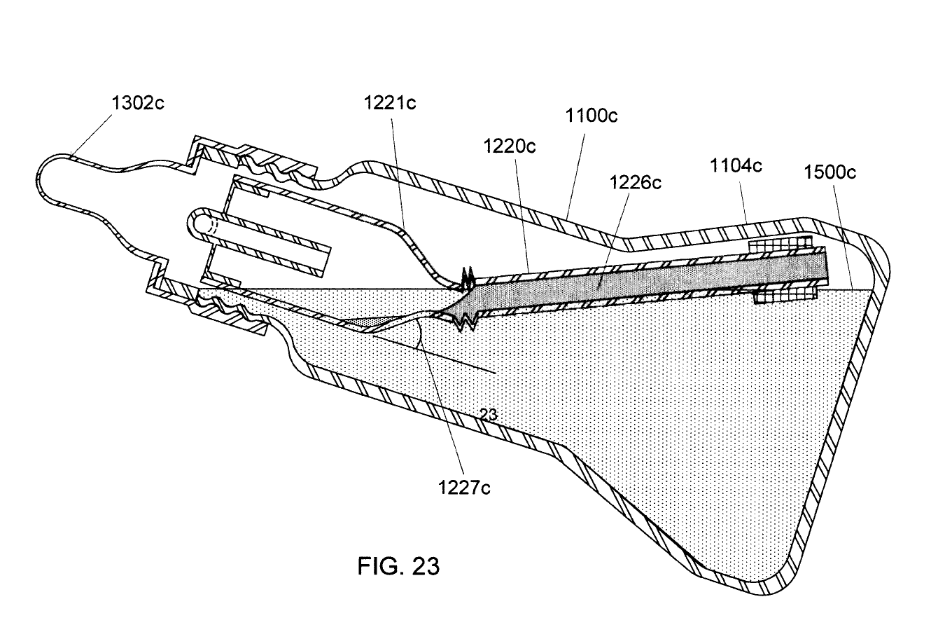

A third alternate embodiment (not shown) incorporates the vent insert 1210 and reservoir tube 1220 into a single element. Likewise, a fourth alternate embodiment (not shown) incorporates the nipple 1300 and collar 1400 into one element. A fifth alternate embodiment is illustrated in FIG. 23. In this embodiment, the shape of the container 1100c is altered to include a widened portion 1104c. In addition, this embodiment incorporates a specific taper 1227c into the reservoir tube 1220c. The required dimensions of the widened portion 1104c and taper 1227c will become apparent in the discussion of the operation of the alternate embodiments which is presented below.

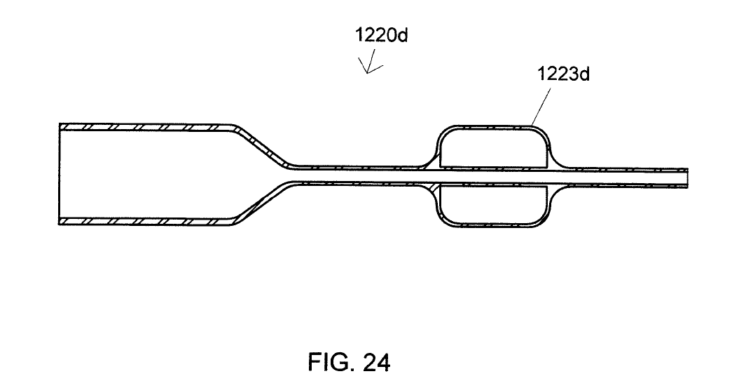

A sixth alternate embodiment is illustrated in FIG. 24. In this embodiment, the buoyant element 1223d is located at an intermediate position on the vent tube 1220d, rather than at its bottom.

### FIGS. 18 Through 24

### Operation of Alternate Embodiments

The operation of the alternate embodiments is substantially identical to the operation of the preferred embodiment. The bottle is assembled, filled to a prescribed, pre-selected level with up to a pre-selected quantity of liquid, and used for feeding. Due to the improvements made to reservoir tube 1220a, 1220b, 1220c and 1220d, respectively, the bottle can be used in a substantially horizontal or inverted orientation, and pressure can be applied to the nipple, such as from chewing, without resulting in leakage.

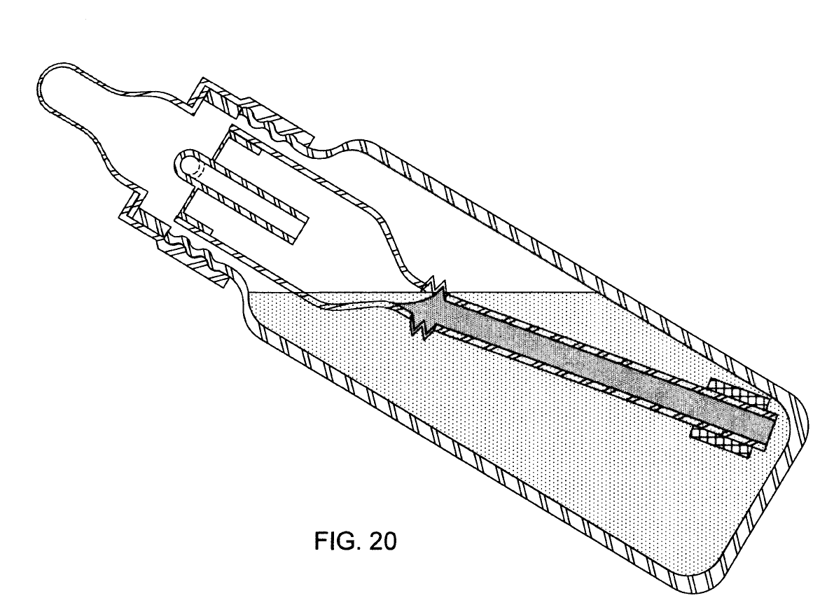

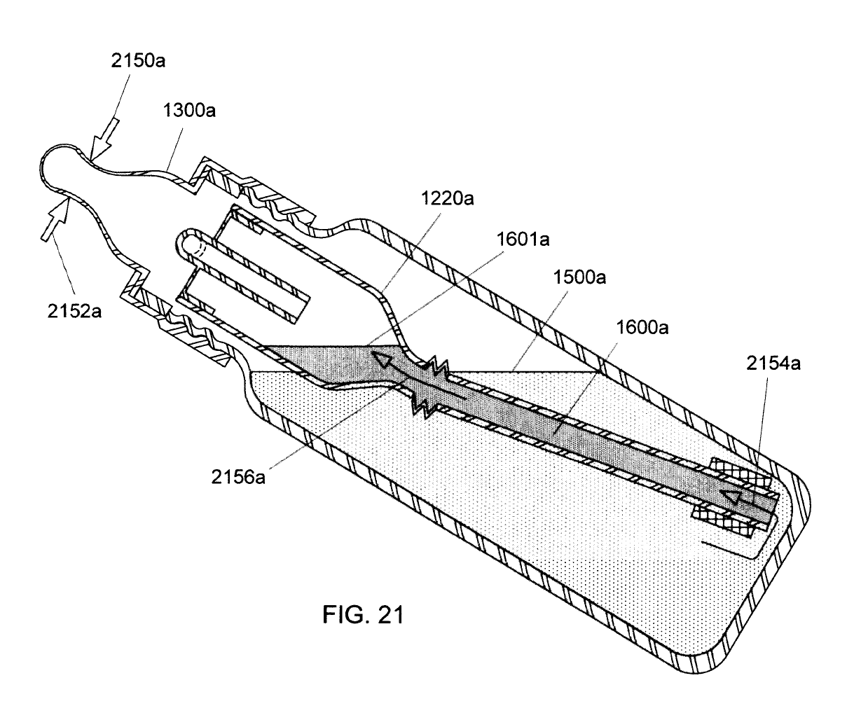

In the fifth alternate embodiment illustrated in FIG. 23, the inclusion of the widened portion 1104c of the container 1100c and the taper 1227c on the reservoir tube 1220c is intended to further improve the leak resistance of the bottle assembly when rotated into a position less than substantially horizontal. Explanation of the benefit of these additional elements is provided below with the aid of FIGS. 20 through 23. FIG. 20 illustrates a bottle assembly of FIG. 18 rotated into an orientation less than horizontal. FIG. 21 illustrates the effect of applying pressure, represented by arrows 2150a and 2152a, to the nipple 1300a when the assembly is in this orientation. As indicated, container liquid 1500a is forced into the reservoir tube 1220a as vent liquid 1600a, illustrated by arrow 2154a, some or all of which becomes reservoir liquid 1601a, with movement represented by arrow 2156a.

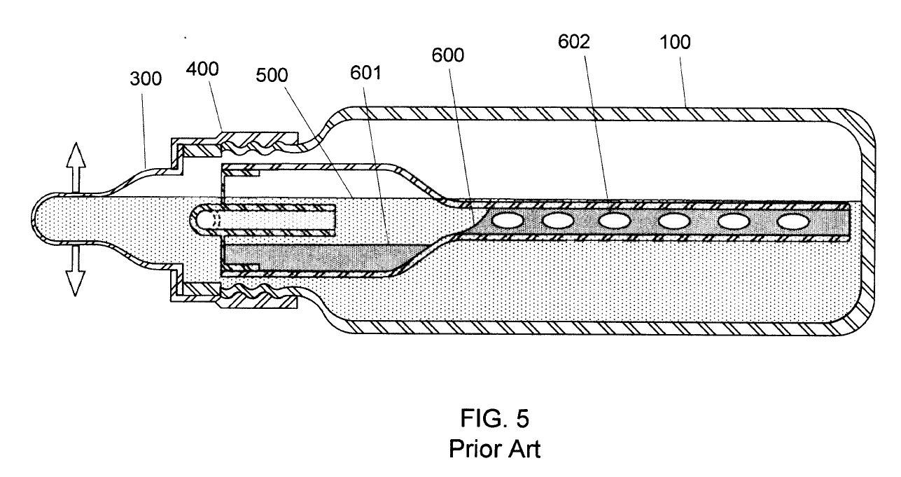

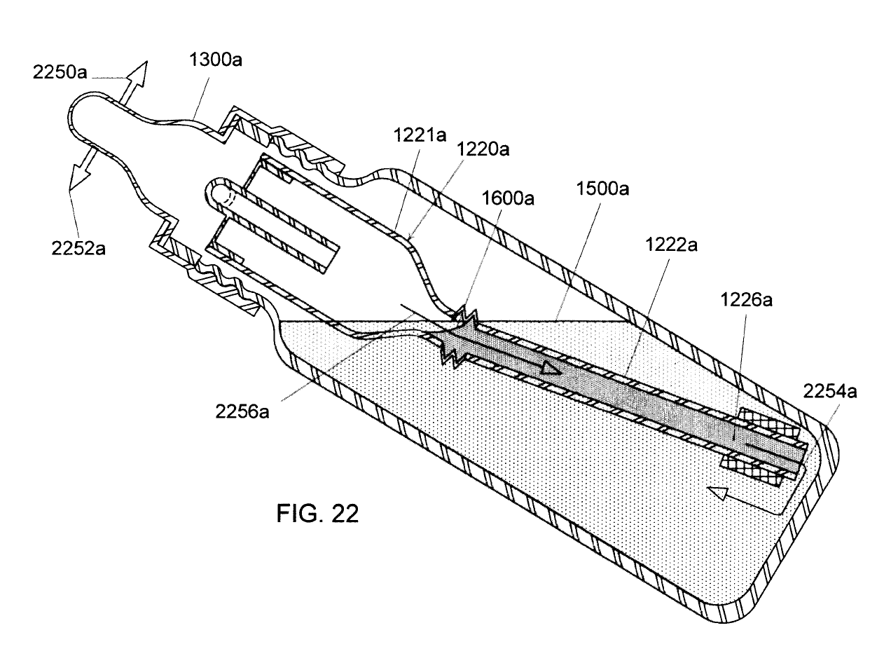

FIG. 22 illustrates the effect of releasing the pressure, represented by arrows 2250a and 2252a, from the nipple 1300a. As the nipple 1300a returns to its normal shape, reservoir liquid 1601a which was forced into reservoir tube 1220a and then into reservoir 1221a is pulled back out, represented by arrows 2256a and 2254a, due to a partial vacuum formed by the nipple regaining its normal shape. Reservoir liquid 1601a is forced back out, represented by arrow 2256a, rather than air bubbles as illustrated in FIG. 5 because liquid, rather than air, is adjacent to the central opening and passage 1226a in the stem 1222a. Therefore, liquid does not accumulate in the reservoir 1221a with successive applications of pressure to the nipple 1300a as it does with the prior art design in a horizontal position.

FIG. 23 illustrates a bottle assembly rotated into a position closer to horizontal than FIGS. 20 through 22. As indicated, this bottle assembly incorporates a widened portion 1104c of the container 1100c and a taper 1227c in the reservoir tube 1220c. Because of the widened portion 1104c, the bottom of the central opening 1226c of the reservoir tube 1220c is free to float above the liquid level. If the bottle assembly was to be rotated counter-clockwise towards and beyond horizontal from the position shown in FIG. 23, the bottom of the central opening 1226c would remain above the liquid level, and thus, any pressure applied to the nipple could not allow accumulation of liquid in the reservoir 1221c resulting in leakage, since only the liquid in the central opening 1226 could flow into the reservoir 1221c. Alternately, if the bottle assembly was to be rotated clockwise back toward vertical from the position shown in FIG. 23, and pressure was applied to the nipple, liquid would first enter, but then be forced back out of the reservoir 1221c as the pressure is relieved since the geometry (including the taper 1227c) ensures that liquid, rather than air, is adjacent to the central opening 1226c in the stem 1222c. Thus, regardless of angular orientation, liquid cannot leak from the bottle. It should be noted that the likelihood that the bottle assembly would be held in the orientation illustrated in FIG. 23 (i.e. less than horizontal) for a substantial period is small, since the liquid is not at the nipple central hole 1302c and therefore the baby is unlikely to maintain the assembly in this position during feeding. Therefore, the additional benefit of including the widened portion 1104c and specific taper 1227c should be weighed against any additional cost associated with manufacturing and possible lack of aesthetic appeal.

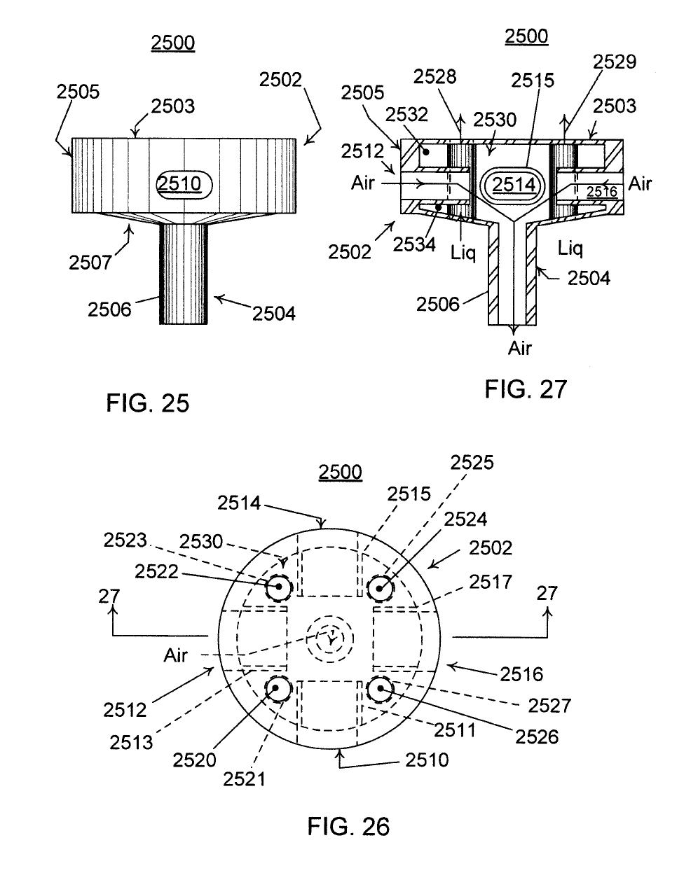

### FIGS. 25-34

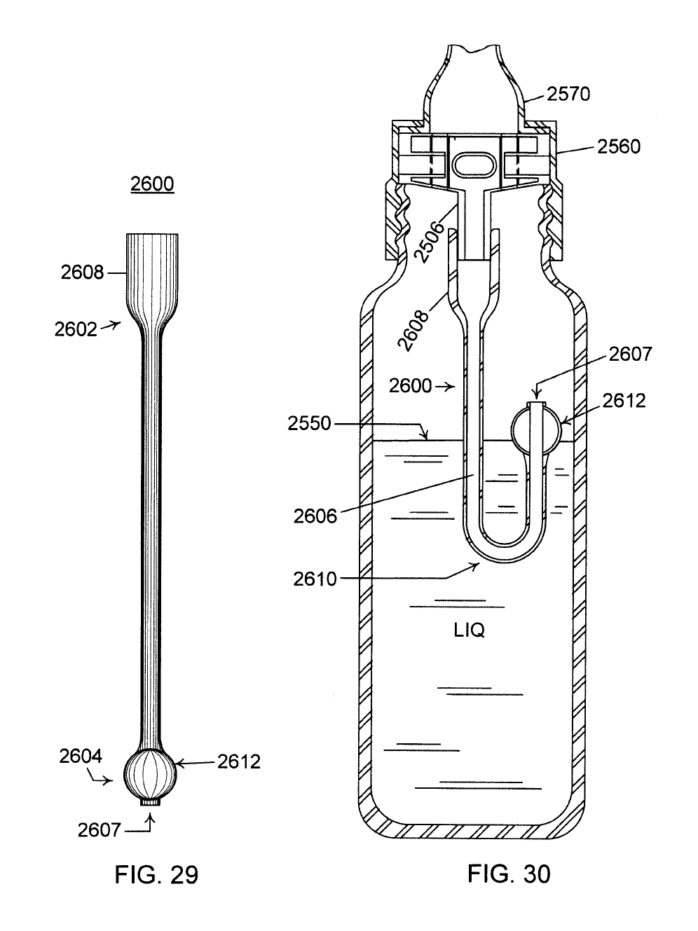

An alternative vent insert 2500 according to the present invention is illustrated in FIGS. 25 through 28A having an upper portion 2502 capable of sealingly engaging an opening 2542 in an upper region 2544 of a container 2540, FIG. 28B. The vent insert 2500, FIGS. 25-28B, has a lower portion 2504 including a vent tube 2506 communicating with the atmosphere through spaced-apart air passages 2510, 2512, 2514 and 2516 in the upper portion established by interior walls 2511, 2513, 2515 and 2517, respectively. The upper portion 2502 also defines spaced-apart channels 2520, 2522, 2524 and 2526, established by separate interior walls 2521, 2523, 2525 and 2527, respectively, for liquid in the container 2540 to flow past the opening in the container, as indicated by arrows 2528 and 2529 in FIGS. 27, 28A and 28B when liquid is directed against underside 2507, FIG. 25, and flows through at least channels 2522 and 2524 in the illustrated orientation to reach nipple 2570, FIG. 28B, without contacting collar 2560.

In this construction, the upper portion 2502 of the vent insert 2500 defines at least one collection chamber 2530 to hold liquid drained from the vent passage of the vent conduit when the container is realigned from the vertical position to the horizontal position. A substantially enclosed space is formed within vent insert by top wall 2503, side wall 2505 and bottom wall 2507 as best shown in FIGS. 25, 27 and 28A. In the horizontal orientation shown in FIG. 28A, liquid emerging through vent tube 2506 from a vent conduit is collected in chambers 2532 and 2534, which are contiguous about wall 2513 in this construction, up to interior rim 2536 of interior wall 2513 to provide a total collection volume indicated by bracket 2538.

A novel vent conduit 2600, FIGS. 28B-30, according to the present invention has upper and lower ends 2602 and 2604, FIG. 29, and defines a vent passage 2606, FIGS. 28B and 30, extending there-between, with lower opening 2607. The upper end 2602 has a slightly flared section 2608 connectable directly with the vent tube 2506 to communicate with the atmosphere. At least a portion 2610 of the vent conduit is flexible as shown in FIG. 30 such that at least one buoyant element 2612 associated with the vent conduit 2600 enables the lower end 2604 of the vent conduit to float in liquid LIQ, FIG. 30, within the container 2540 to maintain opening 2607 in contact only with air even when the container is in the upright, vertical position shown in FIG. 30 filled with liquid up to indicia line 2550. Preferably, buoyant element 2612 enables lower end 2604 to float at least when the container is realigned from a vertical position to a horizontal position as shown in FIG. 28A for the vent insert 2500 and as described above for other embodiments. Gas compartments or bladders 2614 and 2616, FIG. 28B, are formed as a single, toroidal chamber in one construction, as two or more chambers in some constructions, and as at least one solid, low-density material in other constructions.

Another vent insert 2700 according to the present invention is shown in FIGS. 31-34 also having at least one collection chamber 2706, 2708 for vent liquid in an upper portion 2702. While vent insert 2600, FIGS. 25-28B, is substantially symmetrical, vent insert 2700 is not entirely symmetrical by virtue of air manifold 2710 which connects vent tube 2704 to spaced-apart openings 2712 and 2714 defined by walls 2713 and 2715, respectively.

Liquid within a container passes through one or more of openings 2720, 2722, 2724 and 2726 in floor 2730 to reach a liquid receptacle volume 2732 which communicates with a feeding device such as a nipple. Arrows 2725 and 2727, FIG. 34, represent liquid flow through openings 2722 and 2724, FIG. 32, respectively. In one construction, a flange of the nipple serves as a top wall or barrier by spanning outer concentric wall 2734 and inner concentric wall 2736; in other constructions, vent insert 2700 is formed with a top wall spanning concentric walls 2734, 2736 without blocking receptacle volume 2732.

Although specific features of the present invention are shown in some drawings and not in others, this is for convenience only as each feature may be combined with any or all of the other features in accordance with the invention. While there have been shown, described, and pointed out fundamental novel features of the invention as applied to a preferred embodiment thereof, it will be understood that various omissions, substitutions, and changes in the form and details of the devices illustrated, and in their operation, may be made by those skilled in the art without departing from the spirit and scope of the invention. For example, it is expressly intended that all combinations of those elements and/or steps that perform substantially the same function, in substantially the same way, to achieve the same results be within the scope of the invention. Substitutions of elements from one described embodiment to another are also fully intended and contemplated. It is also to be understood that the drawings are not necessarily drawn to scale, but that they are merely conceptual in nature. The alternate embodiments described above may be implemented singly or in any combination to suit the specific needs of the end user, and although the descriptions above contain many specifics, these should not be construed as limiting the scope of the invention, but merely providing illustrations of some of the presently preferred embodiments. Thus, the scope of the invention should be determined by the appended claims and their legal equivalents, rather than by the examples given. Other embodiments will occur to those skilled in the art and are within the following claims.

What is claimed is:

1. An improved vent unit for a container capable of carrying a quantity of liquid, the vent unit comprising:
a vent insert having an upper portion capable of sealingly engaging an opening in an upper region of the container and having a lower portion including a vent tube communicating with the atmosphere through at least one air passage in the upper portion, and the upper portion defining at least one channel for liquid in the container to flow past the opening in the container;
a vent conduit having upper and lower ends and defining a vent passage there-between, the upper end being connectable with the vent insert to communicate with the vent tube, and at least a portion of the vent conduit being flexible; and
at least one buoyant element associated with the vent conduit to enable the lower end of the vent conduit to float in liquid within the container at least when the container is realigned from a vertical position to a horizontal position.

2. The vent unit of claim 1 wherein the upper end of the vent conduit includes an expanded reservoir region which envelops the vent tube.

3. The vent unit of claim 1 wherein the upper end of the vent conduit is connectable directly with the vent tube of the vent insert.

4. The vent unit of claim 1 wherein the upper portion of the vent insert defines at least one collection chamber to hold liquid drained from the vent passage of the vent conduit when the container is realigned from the vertical position to the horizontal position.

5. The vent unit of claim 1 wherein the buoyant element includes at least one chamber containing a gas.

6. An improved vent unit for a container capable of carrying a quantity of liquid, the vent unit comprising:
a vent insert having an upper portion capable of sealingly engaging an opening in an upper region of the container and having a lower portion including a vent tube communicating with the atmosphere through at least two spaced-apart air passages in the upper portion, and the upper portion defining at least two spaced-apart channels for liquid in the container to flow past the opening in the container;
a vent conduit having upper and lower ends and defining a vent passage there-between, the upper end being connectable with the vent insert to communicate with the vent tube, and at least a portion of the vent conduit being flexible; and
at least one buoyant element associated with the vent conduit to enable the lower end of the vent conduit to float in liquid within the container at least when the container is realigned from a vertical position to a horizontal position.

7. The vent unit of claim 6 wherein the upper end of the vent conduit includes an expanded reservoir region which envelops the vent tube.

8. The vent unit of claim 6 wherein the upper end of the vent conduit is connectable directly with the vent tube of the vent insert.

9. The vent unit of claim 8 wherein the upper portion of the vent insert defines at least one collection chamber to hold liquid drained from the vent passage of the vent conduit when the container is realigned from the vertical position to the horizontal position.

10. The vent unit of claim 6 wherein the buoyant element includes at least one chamber containing a gas.

11. An improved bottle assembly, comprising:
a bottle having an opening in an upper region and capable of carrying a pre-selected quantity of liquid in at least a lower region of the bottle; and
a vent unit including:
(a) a vent insert having an upper portion capable of sealingly engaging the opening in the bottle and having a lower portion including a vent tube communicating with the atmosphere through at least two spaced-apart air passages in the upper portion, and the upper portion defining at least two spaced-apart channels for liquid in the bottle to flow past the opening in the bottle;
(b) a vent conduit having upper and lower ends and defining a vent passage there-between, the upper end being connectable with the vent insert to communicate with the vent tube, and at least a portion of the vent conduit being flexible; and
(c) at least one buoyant element associated with the vent conduit to enable the lower end of the vent conduit to float in liquid within the bottle at least when the bottle is realigned from a vertical position to a horizontal position.

12. The bottle assembly of claim 11 wherein the bottle carries at least one visible indicia of liquid fill level for the pre-selected quantity of liquid.

13. The bottle assembly of claim 11 further including a nipple securable to the upper portion of the vent insert to receive liquid passing through the channels in the vent insert.

14. The bottle assembly of claim 13 further including a collar element releasably engagable with the upper region of the bottle to secure the nipple to the bottle while enabling atmospheric air to reach the at least one air passage in the vent insert.

15. The bottle assembly of claim 11 wherein the vent insert which includes a flange with outside dimensions substantially equal to the outside dimensions of the bottle opening, with an internal passage which extends from the side of the flange to its underside, with at least one opening through the flange body to allow passage of liquid.

16. The bottle assembly of claim 11 wherein the vent conduit is sized lengthwise so that the bottom of the tube is in close proximity to the bottom of the bottle after the vent insert is installed in the bottle.

17. The bottle assembly of claim 12 wherein the upper end of the vent conduit includes an expanded reservoir region which envelops the vent tube.

18. The bottle assembly of claim 17 wherein the inside volume of the reservoir region is sized so that a volume of liquid equal to the inside volume of the vent conduit contained inside the reservoir region could not submerge the vent tube lower end regardless of the spatial orientation of the bottle assembly when the bottle is filled with a quantity of liquid not exceeding the pre-selected quantity.

19. The vent unit of claim 12 wherein the upper end of the vent conduit is connectable directly with the vent tube of the vent insert.

20. The vent unit of claim 19 wherein the upper portion of the vent insert defines at least one collection chamber to hold liquid drained from the vent passage of the vent conduit when the container is realigned from the vertical position to the horizontal position when the bottle is filled with a quantity of liquid not exceeding the pre-selected quantity.

21. The bottle assembly of claim 14 wherein the nipple includes a body with a hole through which liquid can be drawn, and a flange with outside dimensions substantially equal to the outside dimensions of the bottle around the opening.

22. The bottle assembly of claim 21 wherein the collar includes an upper portion sized to accommodate the thickness of the vent unit flange and nipple flange, and a lower portion with at least one element which releasably mates with the bottle.

23. The bottle assembly of claim 11 wherein the vent conduit and the buoyancy element are integrally formed as a single, unitary component.

24. The bottle assembly of claim 11 wherein the vent insert and vent conduit are formed as a single unit.

25. The bottle assembly of claim 11 wherein the bottle includes a widened portion sized allow the bottom opening of the vent conduit to float above the liquid surface when the assembly is rotated into a position less than horizontal.

26. The bottle assembly of claim 13 wherein the vent conduit includes a taper which allows liquid forced into the vent conduit by external pressure applied to the nipple to flow back out of the vent conduit when said pressure is relieved, and when the assembly is rotated into a position less than horizontal.
